(19) United States
(12) Patent Application Publication
(10) Pub. No.: US 2019/0238964 A1
(43) Pub. Date: Aug. 1, 2019

(54) Acoustic Earpiece System

(71) Applicant: Sound Sleep Solutions, LLC, Berkeley, CA (US)

(72) Inventor: Jordan Michael Sax, Berkeley, CA (US)

(21) Appl. No.: 15/881,088

(22) Filed: Jan. 26, 2018

(51) Int. Cl. H04R 1/10

(52) U.S. Cl. CPC H04R 1/1016; H04R 1/1083; H04R 1/1066

(57) ABSTRACT

An acoustic earpiece system includes an earpiece housing having a first bore and a second bore, with the first and second bores being defined to join into a common ear canal bore. An adapter connectable to acoustic tubing is also formed, with the adapter being connected to the earpiece housing and the first bore. In some embodiments a passive or active acoustic filter is positionable in the second bore.

### TECHNICAL FIELD

The present disclosure relates to an acoustic earpiece device having dual bores. In certain embodiments, secondary electronics can be supported in the earpiece housing.

### BACKGROUND AND SUMMARY

Portable listening devices such as two-way radios and cellular telephones are often listened to using an acoustic tube connected to an earpiece. Such assemblies are inexpensive compared to electronic wired or wireless systems, and the earpieces are typically lighter and able to be comfortably positioned for long time periods. In addition, for use in areas with a potential for loud sounds such as sirens, aircraft engines, or gunshots, acoustic earpieces can be used to reduce potential for hearing damage. For these reasons, acoustic tube connected earpieces are widely used by first response and emergency personnel, including police, firefighters, ambulance and paramedic, and military.

Unfortunately, conventional earpiece assemblies can greatly lessen a user's ability to respond to ambient sounds or local speech of others. To compensate, many users will have only one ear protected with an earpiece, with the other ear being used to maintain acoustic awareness. This can expose a user to a significant risk of hearing damage or loss.

To address such deficiencies, an acoustic earpiece system can be manufactured that includes an earpiece housing having a first bore and a second bore, with the first and second bores being defined to join into a common ear canal bore. An adapter connectable to acoustic tubing is also, with the adapter being connected to the earpiece housing and the first bore. In some embodiments a passive or active acoustic filter is positionable in the second bore.

Various alternatives and embodiments are described and illustrated herein, including provision of first and second bores defined to extend in a parallel spaced apart relationship before joining near an ear canal insert section, or continuing in parallel to their termination point on the inner surface of the earpiece. Alternatively, the first and second bores can join near the acoustic tubing adapter, define a Y-shape join, or meet near the ear canal bore. In other embodiments, the second bore is defined to surround at least a portion of the first bore. In some configurations the first and second bores are defined by material of the earpiece housing, while in others at least a portion of one of the first and second bores are defined by discrete tubing separate from material of the earpiece housing. In all the various embodiments, the earpiece housing can be formed at least in part using additive three-dimensional manufacturing.

Secondary electronics, including a driven speaker or armature driver positioned in the earpiece housing for noise cancellation or a physiologic or environmental sensor positioned in the earpiece housing. Physiologic sensors can include pulse sensors, and in certain embodiments pulse flow, and other activity can be detected using a CMUT sensor positioned in the earpiece housing.

Also disclosed is a method for forming an acoustic earpiece system. The method involves the sequential steps of creating an ear impression and sending related digital files to an earpiece assembly; selecting an earpiece design compatible with the ear impression; and forming the compatible earpiece housing to have a first bore and a second bore, with the first and second bores being defined to join into a common ear canal bore. The earpiece housing can further define an adapter connectable to acoustic tubing and the first bore.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 generally illustrates one embodiment of an acoustic earpiece system;

FIG. 2 illustrates another embodiment of an acoustic earpiece system;

FIG. 3 illustrates an embodiment of an acoustic earpiece system with inserted acoustic filter;

FIG. 4 illustrates a side view of the embodiment of FIG. 3;

FIG. 5 illustrates positioning of the embodiment of FIG. 3 in an ear;

FIG. 6 illustrates a method for creating customized dual bore earpieces;

FIG. 7. illustrates an embodiment supporting secondary electronics suitable for audio or sensing applications;

FIG. 8 illustrates an alternative embodiment with dual parallel bores;

FIG. 9 illustrates an alternative embodiment where the first and second bores join near the acoustic tubing adapter;

FIG. 10 illustrates an alternative embodiment where the second bore is defined to surround at least a portion of the first bore; and

FIG. 11 illustrates an alternative embodiment where at least a portion of one of the first and second bores are defined by discrete tubing separate from material of the earpiece housing;

### DETAILED DESCRIPTION

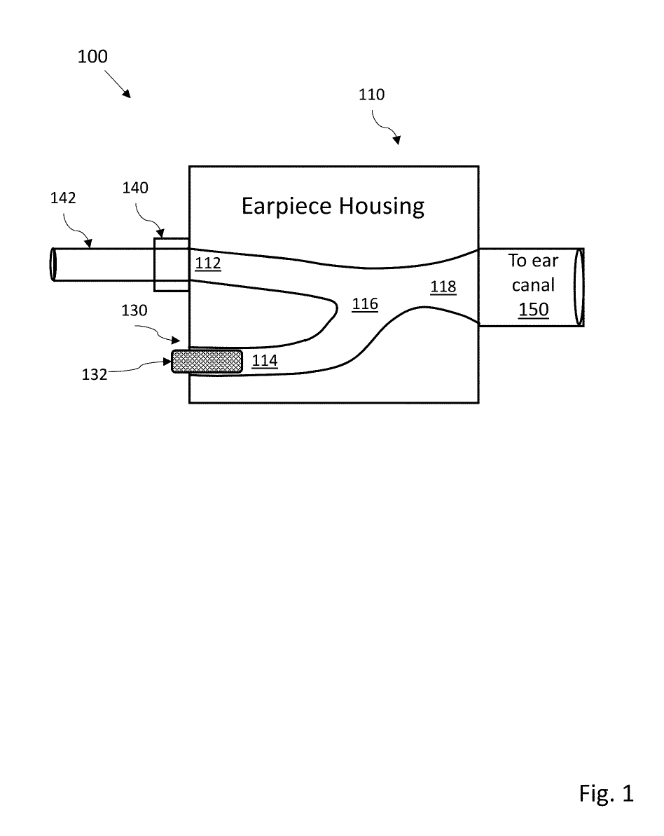

FIG. 1 generally illustrates one embodiment of an acoustic earpiece system 100 including an earpiece housing 110. The earpiece housing 110 includes a first bore 112 that is joinable with a second bore 114 at a junction 116. The joined bores continue as bore 118 until terminating in an exit 150 positionable in or near an ear canal. The first bore 112 can be connected via an adapter 140 to acoustic tubing 142. The second bore 114 has an entrance 130 that can be fitted with an acoustic filter 132. In certain embodiments, secondary electronics (not shown), including but not limited to speakers or sensor systems, can also be supported by the earpiece housing 110.

The earpiece housing 110 can be composed of multiple parts or integrally formed. For those embodiments with multiple parts, the parts can be removable to allow for cleaning and replacement, or can be assembled and permanently fixed in place by adhesives, thermal treatment, ultrasonic treatment, or threaded, frictional, or material interlock. Some parts can include piping, tubing, or manifold structures. Materials used in an earpiece housing can include resilient or elastomeric plastics, including silicone, vinyl, or foam plastics. For certain parts, more rigid plastic materials such as thermoplastics, including acrylonitrile butadiene styrene (ABS), polycarbonate, or polyethylene can be used. In other embodiments, metals such as aluminum, steel, or titanium can be used, as well as structural non-metals such as carbon fiber, ceramic or glass. Use of mixed materials is also possible, with for example, a rigid metal or plastic shell covered in a softer resilient silicone or polyurethane foam. Manufacture using casts, molds, injection molding, subtractive processing, or three-dimensional additive manufacture is possible.

In certain embodiments, the earpiece can have either a full filled concha or a skeleton concha (with open space in the concha) design suitable for fitting within the concha of an ear. Also supported are half shell designs with an omitted helix region, or designs with a canal lock. In other embodiments the earpiece housing has a substantial part formed to fit within an ear canal. In some embodiments the earpiece housing can be custom fitted to a user's ear dimensions. The ear dimensions can be determined by digital ear scans, or alternatively, an ear mold can be scanned with a three-dimensional scanner.

Bores 112, 114, and 118 can be formed to have a wide range of sizes, shapes, and cross-sectional configurations. Typically, bore 112 will have a circular cross section of between 1.5 to 2.5 mm to match the inner diameter of associated acoustic tubing. Alternative embodiments allow for elliptical, rectangular, square, triangular, polygonal, or irregular cross sections. In some embodiments the bore cross section can change along the bore length, with for example, an initial circular cross section being modified to an elliptical cross section with a larger diameter on both major and minor axes. In other embodiments, the cross-sectional shape can remain unchanged, but diameter can be increased or decreased. In some embodiments, the bore can be defined as an integral cavity defined within the earpiece housing, while in other embodiments one or more bores can be piping or tubing encapsulated or extending through a cavity within the earpiece housing.

The adapter 140 can include a threaded, snap, friction, or other suitable mechanical or adhesive attachment mechanism to acoustic tubing 142. The acoustic tubing 142 can be straight, coiled, or combinations of straight and coiled. The acoustic tubing 142 can have a standard size of 2.9 mm outer diameter and 1.9 mm inner diameter, but in other embodiments can have inner and outer diameters that range from a 1.3 to 2.4 mm inner diameter and a 4.4 to 2.2 mm outer diameter. Typically, the acoustic tubing has a length ranging from 5 cm to 100 cm. In some embodiments single or multiple acoustic tubes can be split (“Y” configuration) or otherwise connected to connect to left and right earpieces.

The acoustic tubing 142 can be connected to radios, smartphones, cellphones, listening devices, music players, or sensor analysis platforms. In some embodiments, the acoustic tubing can incorporate electrical wiring to power secondary electronic devices (e.g. electronic speakers or sensor systems) associable with the earpiece, as well as transfer digital or analog data to and from the secondary electronic devices.

The acoustic filter 132 can be sound blocking, with material that acts to muffle all frequencies equally. In other embodiments, the acoustic filter can be pre-tuned to target specific frequencies. For example, in one embodiment the acoustic filter can be tuned to allow normal speech frequencies to pass through the filter, while blocking higher and lower frequencies. In other embodiments, the acoustic filter can be substituted or enhanced with a dynamic electronic filter with noise cancelling properties.

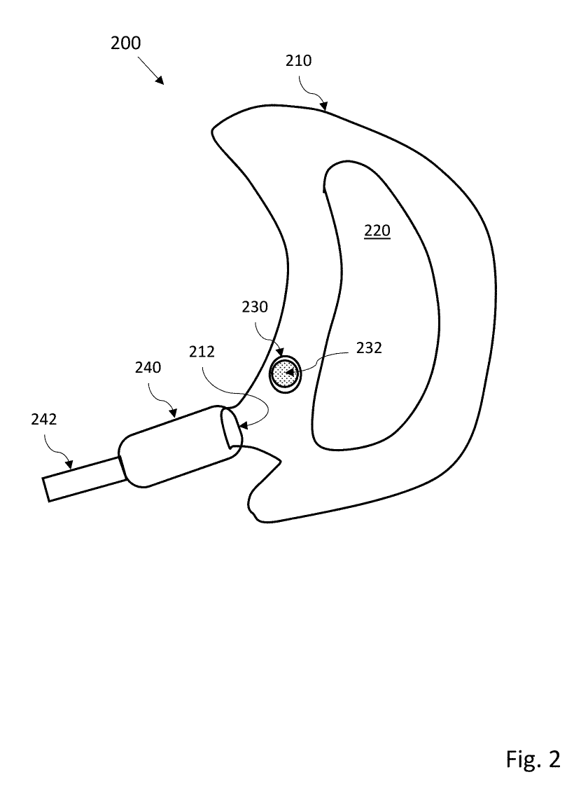

FIG. 2 illustrates generally illustrates one embodiment of an acoustic earpiece system 200 including an earpiece housing 210 shaped as a skeleton concha. The earpiece housing 210 includes a first bore 212 that is joinable with a second bore (not shown). The first bore 212 can be connected via an adapter 240 to acoustic tubing 242. The second bore has an entrance 230 that can be fitted with an acoustic filter 232.

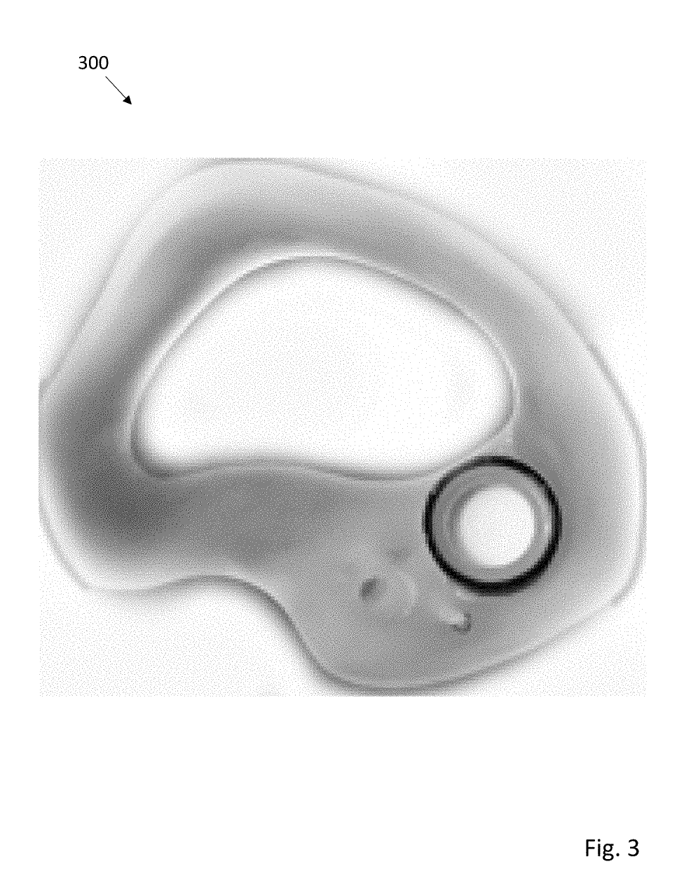

FIG. 3 is a picture 300 illustrating another embodiment of an acoustic earpiece system with dual bores and an inserted acoustic filter. The acoustic earpiece system can be formed from silicone processed using 3D Printing, CNC Machining, and/or molding and casting.

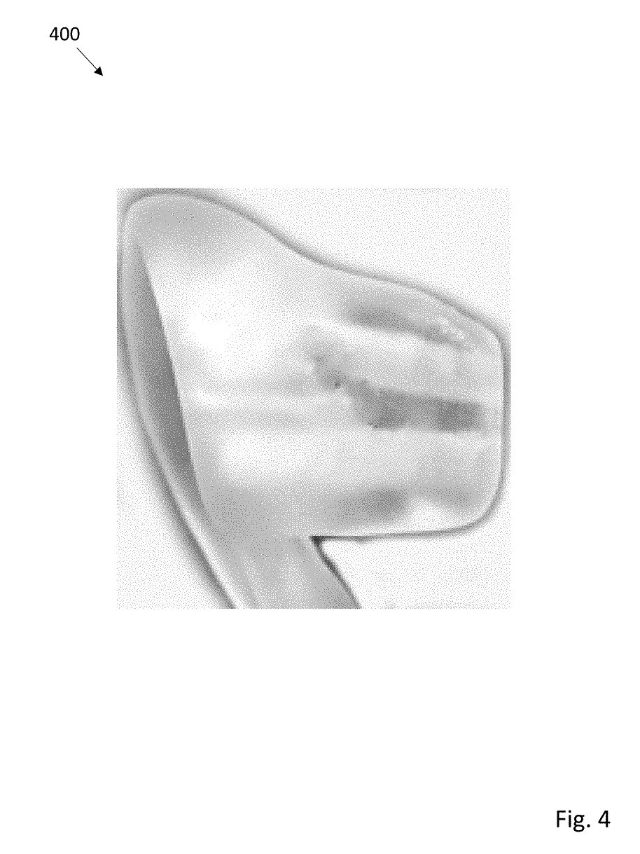

FIG. 4 is a picture 400 illustrating a side view of the embodiment of FIG. 3.

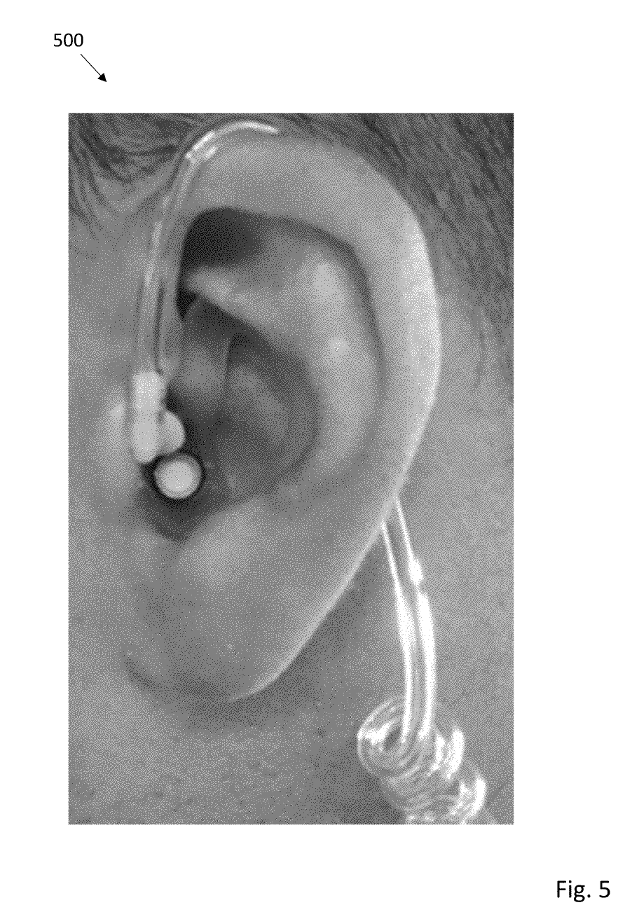

FIG. 5 is a picture 500 illustrating positioning of the embodiment of FIG. 3 in an ear.

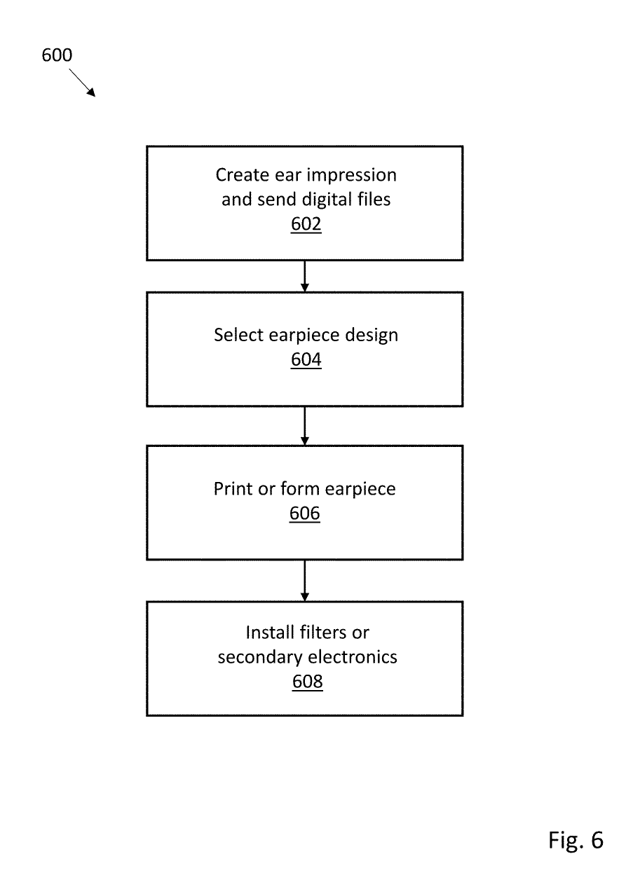

FIG. 6 illustrates a method 600 for creating customized dual bore earpieces. In a first step 602 a three-dimensional ear impression can be created, digitized, and sent as digital files. After an earpiece design is selected (step 604) the earpiece can be printed or formed (step 606). Filters or secondary electronics can be installed (step 608) and the dual bore earpiece is ready for use.

Discussing the process in more detail, a customer's ear impression can be created by physical impression creation with ear injection or by a digital ear scan. The digital ear impression can be uploaded into customer account. This can be a direct upload if digital ear scans are used, or alternatively, an ear mold can be scanned with a three-dimensional scanner and the data uploaded.

Upon customer order, an associated stereolithographic ear scan data file (in, for example, an STL file format) can be imported into 3D modeling software and manipulated into 3D printable file including but not limited to customized earpieces with to form factor including canal style earpiece, concha style earpiece, or canal earpiece with outlined rim of concha bowl (ie “skeleton style”). Earpieces are designed in modeling software to include the following features:

A superior (1^{st}) bore hole (upper position when earpiece in place in ear) traversing the earpiece from the surface of the earpiece to the distal tip (closest to the tympanic membrane). The earpiece can be configured so that an area proximal to the superior bore hole includes an adaptor allowing connection to acoustic tubing. The adaptor can be an additional component, or can be integrally formed by the earpiece as a protrusion, indentation, or other suitable mechanical lock near the bore that is able to accept direct connection with acoustic tubing and/or connection with connectors designed for use with acoustic tubing (including connection by elbow connections, linear connectors, or direct tubing insertion).

An inferior (2^{nd}) bore hole similarly traverses the earpiece from the outer surface to the surface closest to the ear canal (with possible “Y” shape modification as described below). Modification at proximal end (outward facing) to accept commercially available filters (dimensions vary). Modifications can include but are not limited to countersunk or counterbored holes with increased diameter of the sound bore to various depths (filter dependent) to allow installation of filter so that the outer surface is flush, or near flush with the earpiece surface as permitted by the geometry of the custom earpiece (some individuals will have ear canals which permit installation of the filter in a flush position, other individuals will have small ear canals requiring the filter to be only semi-flush)

Audio bore holes are designed to continue to the distal surface of the earpiece in parallel or terminate as discrete bores at the tip of the earpiece. Alternatively, bore holes can be created in a “Y” formation, with two proximal sound holes combining prior to the distal end of the earpiece to create a single sound bore exiting the distal (deep in the ear) end of the earpiece

Earpieces can be either directly printed (acrylic products) on three-dimensional printing platform or printed to at least partially surround an outer shell of earpiece, for example with liquid silicone being injected into the mold, followed by cure in a UV cure chamber (for silicone earpieces), and removal of the outer shell. The earpiece can be finished with lacquer, coloring, engraving, or other cosmetic alterations to fit customer request.

In some embodiments, secondary electronics or filters can be installed, and the earpiece is readied for packaging and shipping to the customer.

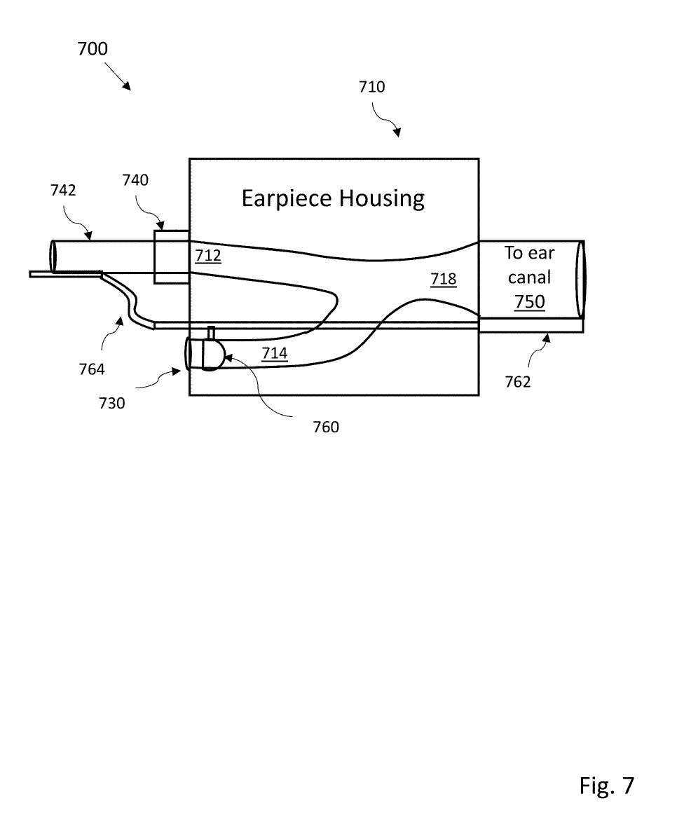

FIG. 7. illustrates an embodiment supporting secondary electronics suitable for audio or sensing applications. Sensing and audio applications can include sensing of personal and physiological data, or environmental sensing (e.g. microphones for recording environmental or ambient sounds. In one embodiment, an acoustic earpiece system 700 includes an earpiece housing 710. The earpiece housing 710 includes a first bore 712 that is joinable with a second bore 714 that continues as bore 718 until terminating in an exit 750 positionable in or near an ear canal. The first bore 712 can be connected via an adapter 740 to acoustic tubing 742. The second bore 714 has an entrance 730 that can be fitted with a dynamic acoustic filter and noise cancellation system that is powered by an earpiece housing supported battery (not shown) or wired connection 764. The secondary electronics can include processors, microphone and speaker systems for active noise cancellation using suitable software programmable algorithms. Necessary parameters and data can be locally stored in the secondary electronics, or accessible by connection to a remote smartphone or other suitable computing platform. The wired connection 764 for power and/or data transfer can be embedded or surface attached to the acoustic tubing 742, while in other embodiments, battery powered and/or wireless data systems can be optionally used.

Other secondary electronics can include sensor electronics 762 (also attachable by wired connection 764) to measure various physiologic properties such as heart beat, pulse, temperature, blood or fluid flow rates, biogas composition and levels, skin or tissue electrical conditions (using inductive or conductive galvanometry), auscultatory signals, and ion or compound detection (using, for example, iontophoresis or electrochemical mediated sensing), or the like. Optical, infrared, pulse oximetry, electrical, thermal, or ultrasonic sensors can be supported. In certain embodiments, capacitive micromachined ultrasonic transducers (CMUT) can be used for acoustic imaging and monitoring of blood flow and other biologic properties. The availability of such a sensor system allows, for example, non-invasive monitoring of a user's life signs, with interruption or dangerous life sign indicators being transmitted to emergency responders or monitoring organizations.

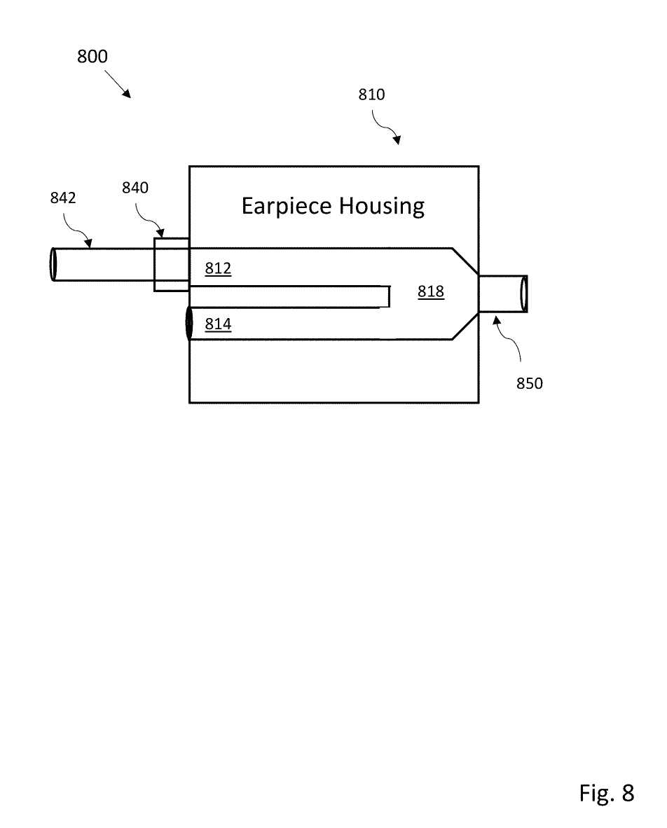

FIG. 8 illustrates an alternative embodiment with dual parallel bores. An acoustic earpiece system 800 includes an earpiece housing 810. The earpiece housing 810 includes a first bore 812 that runs parallel with respect to a second bore 814 , and joins as a bore 818 that terminates in an exit 850 positionable in or near an ear canal. The first bore 812 can be connected via an adapter 840 to acoustic tubing 842.

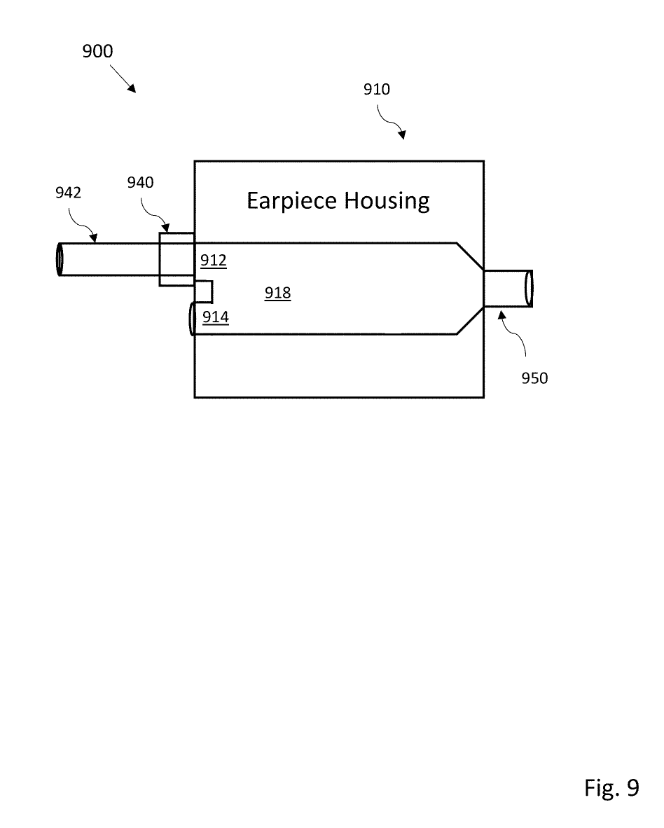

FIG. 9 illustrates an alternative embodiment where the first and second bores join near the acoustic tubing adapter. An acoustic earpiece system 900 includes an earpiece housing 910. The earpiece housing 910 includes a first bore 912 that runs parallel with respect to a second bore 914, and immediately joins as a bore 918 that terminates in an exit 950 positionable in or near an ear canal. The first bore 912 can be connected via an adapter 940 to acoustic tubing 942.

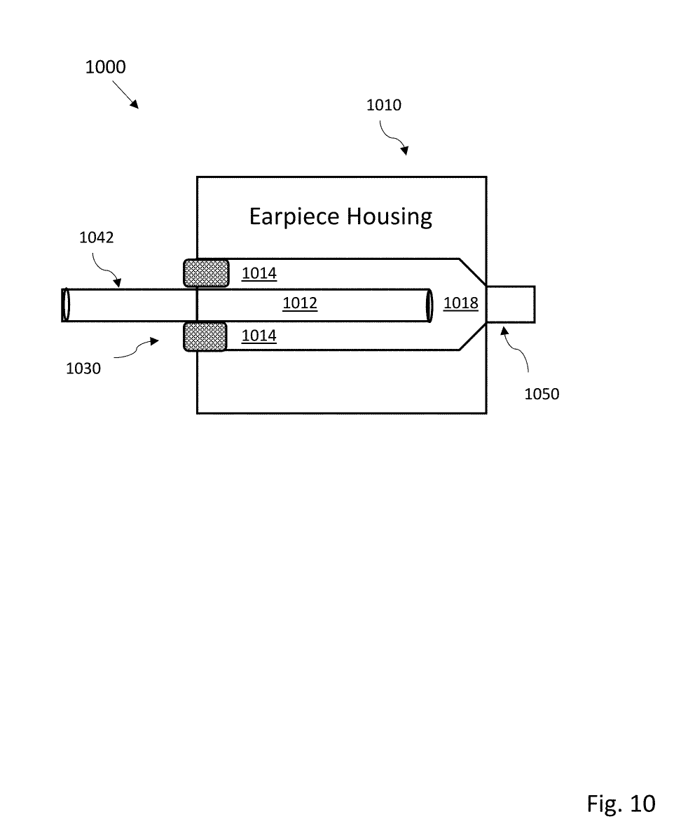

FIG. 10 illustrates an alternative embodiment where the second bore is defined to surround at least a portion of the first bore. An acoustic earpiece system 1000 includes an earpiece housing 1010. The earpiece housing 1010 includes a first bore 1012 that is surrounded by a second bore 1014 and joins as a bore 1018 that terminates in an exit 1050 positionable in or near an ear canal. The first bore 1012 can be connected to acoustic tubing 1042. A second bore entrance 1030 defines an annular region around the first bore 1012 that can be fitted with an annular filter 1014.

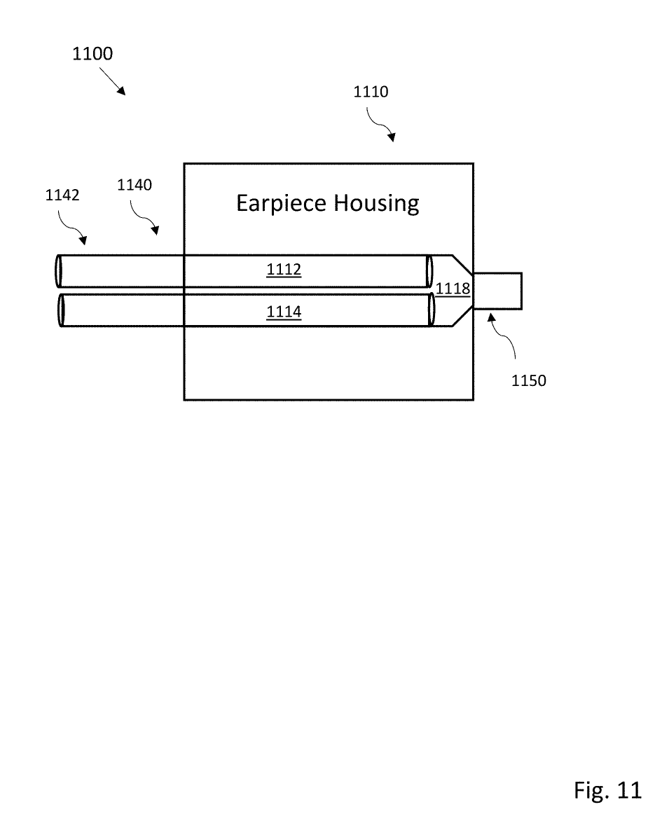

FIG. 11 illustrates an alternative embodiment where at least a portion of one of the first and second bores are defined by discrete tubing separate from material of the earpiece housing. An acoustic earpiece system 1100 includes an earpiece housing 1110. The earpiece housing 1110 includes a first bore 1112 that runs parallel with respect to a second bore 1114, and joins opens into a manifold or bore 1118 that terminates near an exit 1150 positionable in or near an ear canal. The first bore 112 can be connected via an adapter 1140 to acoustic tubing 1142. On or both of bores 1112 and 1114 can be separate tubing fitted into a chamber defined by earpiece housing 1110.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A acoustic earpiece system comprising:
an earpiece housing having a first bore and a second bore, with the first and second bores being defined to join into a common ear canal bore;
an adapter connectable to acoustic tubing, the adapter being connected to the earpiece housing and the first bore; and
an acoustic filter positionable in the second bore.

2. The acoustic earpiece system of claim 1, wherein the first and second bores define extend in a parallel spaced apart relationship before joining near an ear canal insert section.

3. The acoustic earpiece system of claim 1, wherein the first and second bores join near the acoustic tubing adapter.

4. The acoustic earpiece system of claim 1, wherein the first and second bores define a Y-shape.

5. The acoustic earpiece system of claim 1, wherein the first and second bores join near the ear canal bore.

6. The acoustic earpiece system of claim 1, wherein the second bore is defined to surround at least a portion of the first bore.

7. The acoustic earpiece system of claim 1, wherein the first and second bores and the adapter connectable to acoustic tubing are defined by material of the earpiece housing.

8. The acoustic earpiece system of claim 1, wherein at least a portion of one of the first and second bores are defined by discrete tubing separate from material of the earpiece housing.

9. The acoustic earpiece system of claim 1, further comprising secondary electronics including a driven speaker positioned in the earpiece housing for noise cancellation.

10. The acoustic earpiece system of claim 1, further comprising secondary electronics including a sensor positioned in the earpiece housing.

11. The acoustic earpiece system of claim 1, further comprising secondary electronics including a physiologic sensor positioned in the earpiece housing.

12. The acoustic earpiece system of claim 1, further comprising secondary electronics including a pulse sensor positioned in the earpiece housing.

13. The acoustic earpiece system of claim 1, further comprising secondary electronics including a CMUT sensor positioned in the earpiece housing.

14. The acoustic earpiece system of claim 1, wherein the earpiece housing is formed at least in part using additive three-dimensional manufacturing.

15. A method for forming an acoustic earpiece system comprising the steps of:
creating an ear impression and sending related digital files to an earpiece assembly;
selecting an earpiece design compatible with the ear impression;
forming the compatible earpiece housing to have a first bore and a second bore, with the first and second bores being defined to join into a common ear canal bore; and
wherein the earpiece housing further defines an adapter connectable to acoustic tubing and the first bore.

16. The method for forming an acoustic earpiece system of claim 15, wherein acoustic filters are installed in the second bore.

17. The method for forming an acoustic earpiece system of claim 15, wherein secondary electronics are installed in the earpiece housing.

18. The method for forming an acoustic earpiece system of claim 15, wherein the first and second bores are defined by material of the earpiece housing.

19. The method for forming an acoustic earpiece system of claim 15, wherein the compatible earpiece housing is formed at least in part by three-dimensional additive manufacturing.

20. The method for forming an acoustic earpiece system of claim 15, wherein a CMUT sensor is positioned in the earpiece housing.
